(19) United States
(12) Patent Application Publication
(10) Pub. No.: US 2026/0204082 A1
(43) Pub. Date: Jul. 16, 2026

(54) METHOD AND SYSTEM FOR SAFETY EQUIPMENT DETECTION

(71) Applicant: VIA TECHNOLOGIES, INC., New Taipei City (TW)

(72) Inventors: Xiaoxia HU, Beijing (CN); Chao-Chin CHANG, New Taipei City (TW)

(21) Appl. No.: 19/435,951

(22) Filed: Dec. 30, 2025

(30) Foreign Application Priority Data
Jan. 15, 2025 (CN) 202510060148.2

(51) Int. Cl. G06V 20/59; G06V 10/26; G06V 10/40; G06V 10/776; G06V 10/82

(52) U.S. Cl. CPC G06V 20/597; G06V 10/273; G06V 10/40; G06V 10/776; G06V 10/82

(57) ABSTRACT

A method for safety equipment detection is provided. The method includes obtaining an input image containing an occupant, inputting the input image into a pre-trained instance segmentation model to obtain instance segmentation result output by the instance segmentation model, calculating attribute data associated with a safety equipment based on the instance segmentation result, and determining whether the occupant is equipped with the safety equipment based on the attribute data.

### CROSS REFERENCE TO RELATED APPLICATIONS

This Application claims priority of China Patent Application No. 202510060148.2, filed on Jan. 15, 2025, the entirety of which is incorporated by reference herein.

### TECHNICAL FIELD

The present disclosure relates to image analysis technology, and, in particular, to a method and system for detecting safety equipment.

### BACKGROUND

Passive safety equipment is applied to various types of transportation vehicles (e.g., automobiles, motorcycles, trains, airplanes, and yachts), construction vehicles (e.g., forklifts, excavators, and cranes), and amusement facilities (e.g., roller coasters, pirate ships, and free-fall rides), such as seat belts, helmets, lifejackets, and goggles. The primary purpose of such equipment is to mitigate injury to occupants in the event of an accident. In the automotive industry, for example, the application of artificial intelligence technology in Advanced Driving Assistance Systems (ADAS) has gained increasing popularity. Among the core functionalities of ADAS is detecting whether occupants, particularly drivers, are equipped with safety equipment, with the objective of promptly and accurately identifying any failure to use such equipment and issuing timely alerts. It has been shown that the absence of proper use of safety equipment may result in severe or even fatal injuries during accidents. Therefore, research and development in the field of safety equipment detection carries significant practical importance.

Currently, detection of unsafe behavior by occupants typically utilizes object detection techniques, such as identifying the presence of a mobile phone in an image to detect phone usage. Conventional object detection techniques output rectangular bounding boxes that enclose objects, however, these are insufficient for practical safety equipment detection because they cannot adequately describe the attributes of certain types of safety equipment. For instance, in the case of seat belts, their presence within the bounding box is too small, and excessive background information leads to high false detection rates, thereby failing to meet the required level of accuracy for practical applications.

On the other hand, instance segmentation technology involves pixel-level segmentation of regions within an image and identifying the instance class of each region, thereby determining the location and extent of specific objects in the image. Existing instance segmentation models, such as the SparseInst network, may achieve real-time performance and high accuracy when executed on personal computers or server systems. However, due to limitations in computational resources, deploying instance segmentation models into ADAS or similar embedded systems without compromising efficiency and accuracy remains a challenge. In addition to computational constraints, the board support package (BSP) used by some embedded systems may offer limited support for neural networks, and may not support, or completely lack support for, certain specialized neural network layers such as downsampling layers.

Accordingly, there is need for a method and system for detecting safety equipment capable of overcoming the aforementioned technical challenges.

### BRIEF SUMMARY

An embodiment of the present disclosure provides a method for safety equipment detection. The method includes obtaining an input image containing an occupant, inputting the input image into a pre-trained instance segmentation model to obtain instance segmentation result output by the instance segmentation model, calculating attribute data associated with a safety equipment based on the instance segmentation result, and determining whether the occupant is equipped with the safety equipment based on the attribute data.

An embodiment of the present disclosure provides a system for safety equipment detection. The system includes a processing device configured to perform steps including obtaining an input image containing an occupant, inputting the input image into a pre-trained instance segmentation model to obtain instance segmentation result output by the instance segmentation model, calculating attribute data associated with a safety equipment based on the instance segmentation result, and determining whether the occupant is equipped with the safety equipment based on the attribute data.

### BRIEF DESCRIPTION OF THE DRAWINGS

The present disclosure may be more fully understood by reading the subsequent detailed description and examples with references made to the accompanying drawings, wherein:

FIG. 1 is a flow diagram illustrating a method for safety equipment detection, according to an embodiment of the present disclosure;

FIG. 2 illustrates an architectural diagram of a typical SparseInst network;

FIG. 3 is an architectural diagram of a modified SparseInst network, according to an embodiment of the present disclosure;

FIG. 4A is a flow diagram illustrating detailed steps for obtaining the input image containing the occupant in an embodiment;

FIG. 4B is a schematic diagram illustrating detailed steps for obtaining the input image containing the occupant in an embodiment;

FIG. 5 illustrates an example minimum bounding rectangle and the pixel area A of a seat belt, where the minimum bounding rectangle has a height (h), a width (w), and a rotation angle (0); and

FIG. 6 is a system block diagram of a system for implementing the method for safety equipment detection, according to an embodiment of the present disclosure.

### DETAILED DESCRIPTION

The following description is made for the purpose of illustrating the general principles of the disclosure and should not be taken in a limiting sense. The scope of the disclosure is best determined by reference to the appended claims.

In each of the following embodiments, the same reference numbers represent identical or similar elements or components.

Ordinal terms used in the claims, such as “first,” “second,” “third,” etc., are only for convenience of explanation, and do not imply any precedence relation between one another.

The following descriptions of embodiments of the device or system are also applicable to embodiments of the method, and vice versa.

In order to better describe the embodiments of the present disclosure, several key terms involved herein are first defined as follows.

Safety equipment: Any device that may be applied to various types of transportation vehicles (e.g., automobiles, motorcycles, trains, airplanes, and yachts), construction vehicles (e.g., forklifts, excavators, and cranes), and amusement facilities (e.g., roller coasters, pirate ships, and free-fall rides), with the purpose of mitigating injury to occupants in the event of an accident, such as seat belts, helmets, life jackets, and goggles.

Instance segmentation: A technique in the field of computer vision, which involves performing pixel-level segmentation of regions in an image and identifying the instance class of each region, thereby recognizing the location and extent of specific objects in the image.

Attribute data: Data associated with safety equipment, used to describe visible physical properties and/or characteristics of the safety equipment, such as information related to the position, size, shape, orientation, and color of the safety equipment in the image.

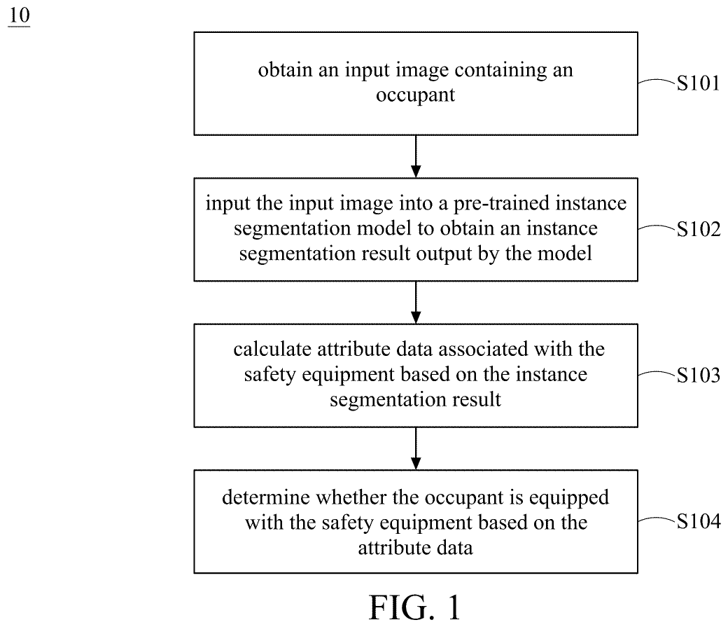

FIG. 1 is a flow diagram illustrating a method 10 for safety equipment detection, according to an embodiment of the present disclosure. As shown in FIG. 1, the method 10 may include steps S101 to S104.

In step S101, an input image containing an occupant is obtained. For example, the input image may be captured from the driver's seat area inside a vehicle and then subjected to certain preprocessing operations, such as geometric transformation, normalization, smoothing, image enhancement, and/or cropping. However, various embodiments of the present disclosure are not limited to vehicle driver detection scenarios, nor restricted to specific preprocessing operations on the captured image. In some embodiments, the input image may originate from application scenarios involving various transportation vehicles (e.g., automobiles, motorcycles, trains, airplanes, and yachts), construction vehicles (e.g., forklifts, excavators, and cranes), amusement facilities (e.g., roller coasters, pirate ships, and free-fall rides), among others.

In step S102, the input image is input into a pre-trained instance segmentation model to obtain an instance segmentation result output by the model. The instance segmentation model involves performing pixel-level segmentation on regions within the image and identifying the instance class of each region to determine the location and extent of specific objects in the image. In the instance segmentation result, the safety equipment is treated as an instance object, and the pixels within its region are labeled by class, for example, “1” for the region corresponding to the safety equipment and “0” for the background region, thereby enabling subsequent identification of the safety equipment in the input image.

In step S103, attribute data associated with the safety equipment is calculated based on the instance segmentation result. For example, the attribute data may include information such as the position, size, shape, orientation, and color of the safety equipment in the image, but the present disclosure is not limited thereto. The safety equipment may include any device used in various transportation vehicles (e.g., automobiles, motorcycles, trains, airplanes, and yachts), construction vehicles (e.g., forklifts, excavators, and cranes), and amusement facilities (e.g., roller coasters, pirate ships, and free-fall rides) that aims to mitigate injury to occupants in the event of an accident, such as seat belts, helmets, life jackets, and goggles.

In step S104, it is determined whether the occupant is equipped with the safety equipment based on the attribute data. Conceptually, if the occupant is properly equipped with the safety equipment, then the safety equipment will appear in the input image with a reasonable position and extent. Therefore, the determination may be made by analyzing the correspondence between the relevant information in the attribute data and the expected position and extent.

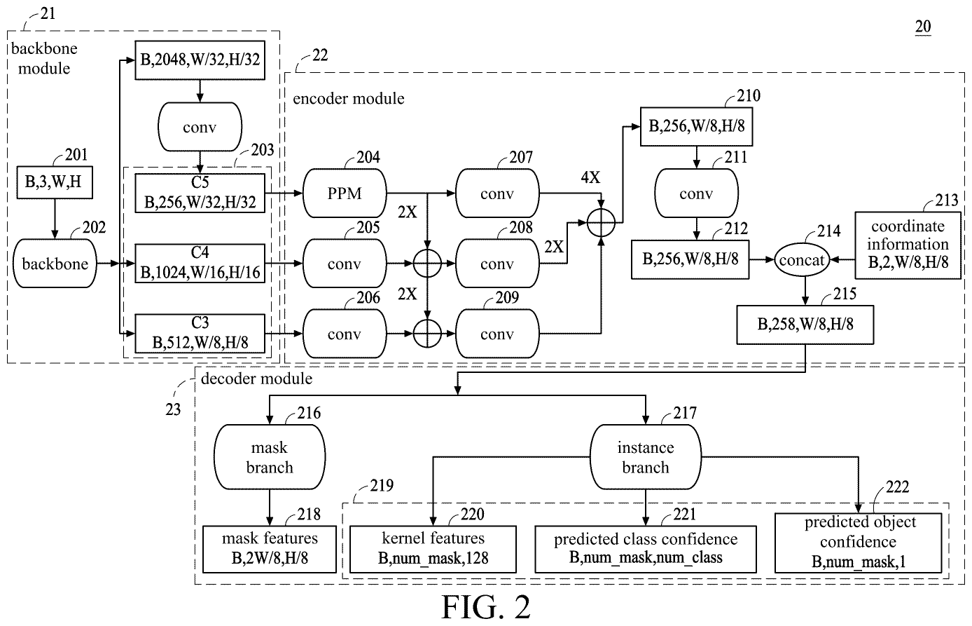

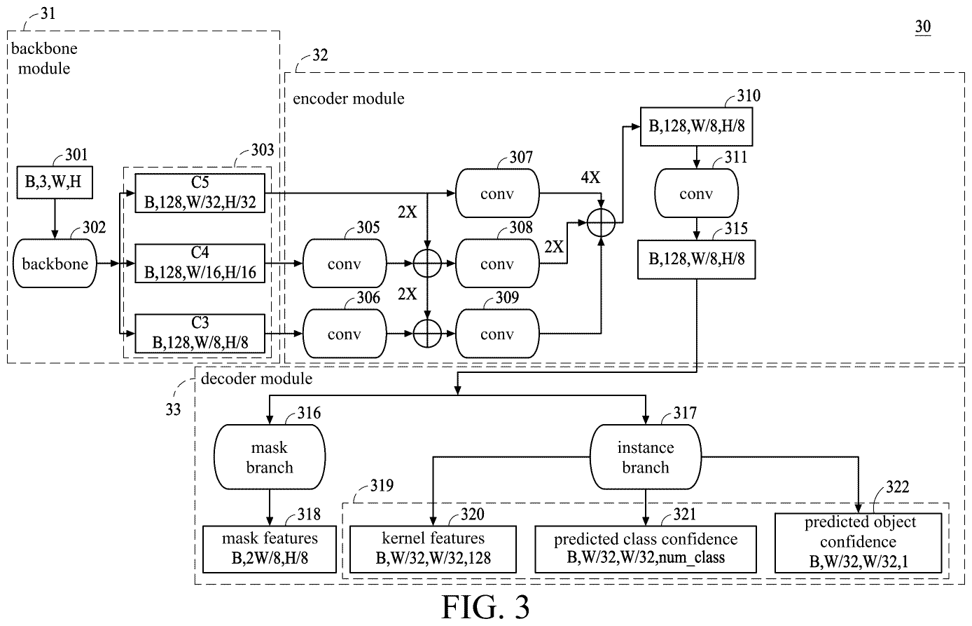

In an embodiment, the above-described instance segmentation model is implemented using a modified SparseInst network. A typical SparseInst network is characterized by a large scale, complex structure, numerous parameters, and specialized network layers, which are unsuitable for deployment on computer systems with limited computational resources and limited support for network types, such as embedded systems. In response to the above issues, certain further embodiments of the present disclosure involve modifications to the typical SparseInst network to broaden its applicability. Various possible modifications to the typical SparseInst network proposed in the present disclosure will be described below with reference to FIG. 2 and FIG. 3.

FIG. 2 illustrates an architectural diagram of the typical SparseInst network 20. As shown in FIG. 2, the typical SparseInst network 20 includes a backbone module 21, an encoder module 22, and a decoder module 23, which will be described in sequence below.

The main function of the backbone module 21 is to extract image features. As shown in FIG. 2, the backbone module 21 receives an input image 201 having a batch size B, 3 channels (i.e., 3 dimensions), width W, and height H (denoted as (B,3,W,H) in the figure). A backbone 202 is used to extract multi-scale features 203 from the input image 201, including feature maps at different levels such as C5, C4, and C3. These levels correspond to different depths of feature extraction. The C3 feature maps contain low-level feature representations, typically with higher spatial information and less semantic information. The C4 feature maps contain mid-level feature representations, with reduced spatial information compared to C3 but enriched semantic content. The C5 feature maps contain high-level feature representations, offering minimal spatial information but the richest semantic content. In the example of FIG. 2, the sizes (i.e., width and height) of the C5, C4, and C3 feature maps are 1/32, 1/16, and ⅛ of the input image 201, respectively, with channel counts of 256, 1024, and 512. The typical backbone 202 is implemented using a residual neural network (ResNet), which involves a large number of parameters and demands substantial storage and computational resources during both training and inference phases.

The main function of the encoder module 22 is to enhance contextual information and fuse the multi-scale features 203. As shown in FIG. 2, the encoder module 22 receives the multi-scale features 203 output from the backbone module 21. The C5, C4, and C3 feature maps undergo operations via a pyramid pooling module (PPM) 204, convolution 205, and convolution 206, respectively. The primary function of the pyramid pooling module 204 is to enlarge the receptive field and integrate features at different scales to enhance the typical SparseInst model's global perception capabilities. The output of C5 after pyramid pooling is processed in two paths: one path undergoes convolution 207 to generate a feature map upscaled by a factor of 4 (i.e., from 1/32 to ⅛ of the input image 201), and another path is upscaled by a factor of 2 and added to the result of C4 after convolution 205 (denoted by e in the figure). The addition result is then processed in two paths: one path undergoes convolution 208 to produce a feature map upscaled by a factor of 2 (i.e., from 1/16 to ⅛ of the input image 201), and the other path is added to the result of C3 after convolution 206, followed by convolution 209 to output a feature map at ⅛ the size of the input image 201. The outputs of convolutions 207, 208, and 209 are then summed to obtain a fused feature map 210 with batch size B, 256 channels, and dimensions W/8 by H/8. This feature map 210 is further processed by convolution 211 to yield feature map 212. Feature map 212 is concatenated with 2D coordinate information (i.e., x and y coordinates) 213 via concatenation operation 214 to form the encoded features 215 with batch size B, 258 channels, and dimensions W/8 by H/8, which serve as the output of the encoder module 22. It is worth noting that, unlike the depiction in FIG. 2, some literature considers feature map 212 as the output of the encoder module 22, and the concatenation of feature map 212 with coordinate information 213 as part of the decoder module 23. Nevertheless, it is certain that the typical feature map 212 involves coordinate concatenation, whether in the encoder module 22 or decoder module 23. Since the positions of different instances vary, the introduction of coordinate information 213 helps the model distinguish between instances.

The main function of the decoder module 23 is to use a sparse set of instance activation maps to emphasize discriminative instance pixels and suppress irrelevant pixels, thereby facilitating classification and segmentation of foreground objects. As shown in FIG. 2, the decoder module 23 includes a mask branch 216 and an instance branch 217. Both branches receive the encoded features 215 output from the encoder module 22 and respectively output mask features 218 and instance information 219. The mask branch 216 mainly consists of a sequence of convolutions to derive the mask features 218 from the encoded features 215. In some literature, mask features 218 are abbreviated as “Mask” and represent the probability that a pixel belongs to a particular instance, thus enabling generation of the instance segmentation result. The instance branch 217 also primarily consists of a sequence of convolutions to derive the instance information 219 from the encoded features 215. The instance information 219 includes kernel features 220, predicted class confidence 221, and predicted object confidence 222. The kernel features 220, often abbreviated as “Kernel,” represent the instance feature representations, i.e., 128-dimensional vectors for each of the num_mask potential instances. The predicted class confidence 221, sometimes abbreviated as “pred_logits,” is a tensor in which each element represents the model's confidence score that a pixel belongs to a particular class, corresponding to num_mask potential instances across num_class categories. The predicted object confidence 222, sometimes abbreviated as “pred_objectness,” indicates the probability score that each of the num_mask potential instances exists.

It should be noted that the mask features 218 output by the mask branch 216 do not constitute the final predicted masks of the model; rather, the instance segmentation result is obtained by combining the mask features 218 with the instance information 219 provided by the instance branch 217. Specifically, the instance segmentation result includes a predicted mask and its corresponding confidence score. The predicted mask is derived by performing a matrix multiplication between the mask features 218 and the kernel features 220 followed by a square root operation. The confidence score is obtained by multiplying the predicted class confidence 221 and the predicted object confidence 222.

The training phase of the typical SparseInst network 20 involves optimizing the network using a training dataset and a loss function. The training dataset includes multiple training samples, each including a training image and corresponding labeled data. The training images may be collected and preprocessed by the developer or obtained from open-source datasets such as Pascal VOC or CoCo (Common Objects in Context). The labeled data may be created using tools such as labelme or similar annotation interfaces by outlining object instances within the training images and assigning class labels. These annotations are then parsed and converted into the specific formats required for training, such as JSON, XML, or CSV files. During training, the training images are input into the typical SparseInst network 20 to obtain instance segmentation predictions corresponding to the input images. The loss function is used to evaluate the discrepancy between the predicted results and the ground truth labeled data during training. This discrepancy determines the direction for parameter updates of the typical SparseInst network 20, typically implemented via gradient descent or its variants such as Stochastic Gradient Descent (SGD), Momentum, AdaGrad, or Adam, in conjunction with a backpropagation algorithm to iteratively update the parameters. After the loss value converges, a testing dataset which is distinct from the training dataset may be used for inference to evaluate the generalization performance of the typical SparseInst network 20, ensuring that it may accurately analyze diverse data. The test results help determine whether the model is overfitting and provide a basis for further optimization.

The loss function used for evaluating and optimizing the typical SparseInst network 20 involves a focal loss, a mask loss, and a binary cross entropy loss, as shown in the following <Equation 1>:

$$L = {λ}_{c} {L}_{cls} + {L}_{mask} + {λ}_{s} {L}_{s} \qquad < Equation 1 >$$

where L denotes the total loss function, L_{cls} represents the focal loss for object classification, Lₘₐₛₖ represents the mask loss between the predicted mask and the ground truth mask, and Lₛ denotes the binary cross entropy loss based on the Intersection over Union (IoU). The coefficients λ_{c} and λₛ are hyperparameters used to mitigate the imbalance between foreground and background classes. To further address this imbalance, the mask loss Lₘₐₛₖ is formulated as a combination of Dice loss and per-pixel binary cross entropy loss, as shown in the following <Equation 2>:

$${L}_{mask} = {λ}_{dice} \cdot {L}_{dice} + {λ}_{pix} \cdot {L}_{pix} \qquad < Equation 2 >$$

where L_{dice} and Lₚᵢₓ represent the Dice loss and the per-pixel binary cross entropy loss between the predicted mask and the ground truth mask, respectively. λ_{dice} and λₚᵢₓ are the corresponding weighting coefficients. More specifically, the Dice loss L_{dice} is computed as shown in the following <Equation 3>:

$${L}_{dice} = \frac{2 {\sum }_{xy} {m}_{xy} \cdot {t}_{xy}}{{\sum }_{xy} {m}_{xy}^{2} + {\sum }_{xy} {t}_{xy}^{2}} \qquad < Equation 3 >$$

where m_{xy} and t_{xy} denote the values of the predicted mask and the ground truth mask at position (x, y), respectively.

FIG. 3 is an architectural diagram of a modified SparseInst network 30, according to an embodiment of the present disclosure. Similar to the typical SparseInst network 20, the modified SparseInst network 30 also includes a backbone module 31, an encoder module 32, and a decoder module 33, with the primary functions of each module corresponding to those of the aforementioned backbone module 21, encoder module 22, and decoder module 23. Specifically, the backbone module 31 involves using a backbone 301 to extract multi-scale features 303 from an input image 301. The encoder module 32 involves performing a series of feature fusion operations on the multi-scale features 303, including convolutions 305-309 and 311, as well as addition operations performed on the convolution results, to obtain encoded features 315. The decoder module 33 includes a mask branch 316 and an instance branch 317, wherein the mask branch 316 involves deriving mask features 318 from the encoded features 315, and the instance branch 317 involves deriving instance information 319 that includes kernel features 320, predicted class confidence 321, and predicted object confidence 322, from the encoded features 315. The instance segmentation model further involves deriving an instance segmentation result from the mask features 318 and the instance information 319, which has been described in detail earlier and will not be repeated here. The following will describe the possible modifications of the modified SparseInst network 30 as compared to the typical SparseInst network 20. It should be understood that, although FIG. 3 illustrates all possible modifications, the present disclosure does not require that all modifications be applied. In various embodiments, a subset of modifications may be selected for application based on practical considerations, such as available system computational resources and/or support for specific types of network layers.

In an embodiment, the backbone 302 used in the backbone module 31 is implemented using a MobileNetV2 network, replacing the ResNet used in the typical backbone 202. MobileNetV2 is a lightweight convolutional neural network with significantly fewer parameters compared to ResNet. Therefore, replacing ResNet with MobileNetV2 as the backbone 302 substantially reduces computational load. In addition, the multi-scale features 303 extracted by the backbone 302, including the C5, C4, and C3 feature maps, each have a dimensionality of 128, which is lower than the respective dimensionalities of 256, 1024, and 512 in the multi-scale features 203. Subsequently, the feature map 310 obtained by adding the outputs of convolutions 307, 308, and 309 also has a dimensionality of 128, which is lower than the 256-dimensional feature map 210 in FIG. 2. This configuration reduces the computational burden on the encoder module 32 and decoder module 33 and improves inference speed.

In an embodiment, the encoder module 32 does not involve a pyramid pooling module. Specifically, the C5 feature maps are directly processed by convolution 307 on one hand, and on the other hand are upscaled by a factor of 2 and added to the result of the C4 feature maps processed by convolution 305. This process no longer involves the pyramid pooling module 204 as depicted in FIG. 2. The removal of the pyramid pooling module further reduces computational requirements and allows the modified SparseInst network 30 to be deployed on embedded systems that support a more limited variety of neural network layers.

In an embodiment, the encoder module 32 and the decoder module 33 both do not involve coordinate concatenation operations. Specifically, the feature map obtained from convolution 311 applied to feature map 310 is directly used as the encoded features 315, which serve as the input to the mask branch 316 and the instance branch 317, without concatenation with coordinate information. This allows the modified SparseInst network 30 to be deployed on embedded systems that do not support coordinate concatenation operations. Furthermore, the training of the instance segmentation model involves optimizing the modified SparseInst network 30 using a modified loss function. To compensate for the absence of coordinate information due to the elimination of coordinate concatenation operations, the modified loss function adds a heatmap loss component on top of the original loss function (as described previously in <Equation 1>), as shown in the following <Equation 4>:

$${L}^{′} = {λ}_{c} {L}_{cls} + {L}_{mask} + {λ}_{s} {L}_{s} + {λ}_{k} {L}_{k} \qquad < Equation 4 >$$

where L′ represents the modified loss function, Lₖ represents the heatmap loss between the predicted class confidence and the ground truth class confidence, and λₖ is a hyperparameter for Lₖ. More specifically, the heatmap loss Lₖ is computed as shown in the following <Equation 5>:

$${L}_{k} = \frac{- 1}{N} {\sum }_{xyc} \{ \begin{matrix}{( 1 - {\hat{Y}}_{xyc} )}^{α} log ( {\hat{Y}}_{xyc} ) \\ {( 1 - {Y}_{xyc} )}^{β} ( {{\hat{Y}}_{xyc} )}^{α} log ( {\hat{Y}}_{xyc} )\end{matrix} \begin{matrix}if {Y}_{xyc} = 1 \\ otherwise\end{matrix} \qquad < Equation 5 >$$

where α=2, β=4, N denotes the total number of classes (which may be set to 1 if only used to detect safety equipment), c represents the class label, Ŷ_{xyc} represents the predicted class confidence at position (x, y) for class c, and Y_{xyc} represents the ground truth class confidence at the same position and class.
The ground truth class confidence Y_{xyc} is calculated as shown in the following <Equation 6>:

$${Y}_{x , y} = exp ( - \frac{{( x - {\hat{p}}_{x} )}^{2} + {( y - {\hat{p}}_{y} )}^{2}}{2 {σ}_{p}^{2}} ) \cdot {m}_{xy} \qquad < Equation 6 >$$

where Y_{x,y} is the ground truth class confidence, m_{xy} is the value of the ground truth mask at position (x, y), and \hat{p}ₓ and \hat{p}_{y} equal 1 if (x, y) is the center point of the object, and 0 otherwise.

In an embodiment, the instance branch 317 involves multiple convolution layers but does not involve any downsampling layers. In other words, the typical instance branch 217 includes downsampling layers, however, in instance branch 317, such downsampling layers are replaced by convolution layers. Therefore, this modification allows the modified SparseInst network 30 to be deployed on embedded systems that do not support downsampling layers. Furthermore, the kernel features 220, predicted class confidence 221, and predicted object confidence 222 derived by the typical instance branch 217 have a fixed size equal to num_mask, i.e., the number of potential instance masks, for example, 20×20. In contrast, the kernel features 320, predicted class confidence 321, and predicted object confidence 322 derived by instance branch 317 have sizes that depend on the dimensions of the input image 301. In the example shown in FIG. 3, the size of the kernel features 320, predicted class confidence 321, and predicted object confidence 322 is 1/32 of the input image 301. For instance, in the typical SparseInst network 20, for input images of size 640×640 and 256×256, the kernel features 220, predicted class confidence 221, and predicted object confidence 222 all have a size of 20×20. In contrast, in the modified SparseInst network 30, the kernel features 320, predicted class confidence 321, and predicted object confidence 322 have sizes of 20×20 and 8×8, respectively. This demonstrates that for instance branch 317, specifying the input image with a lower resolution may significantly reduce the required computational load.

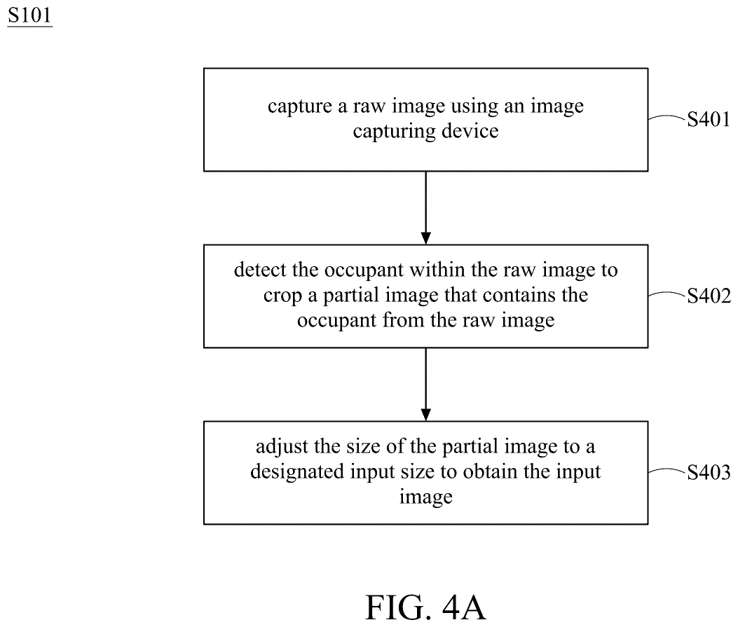

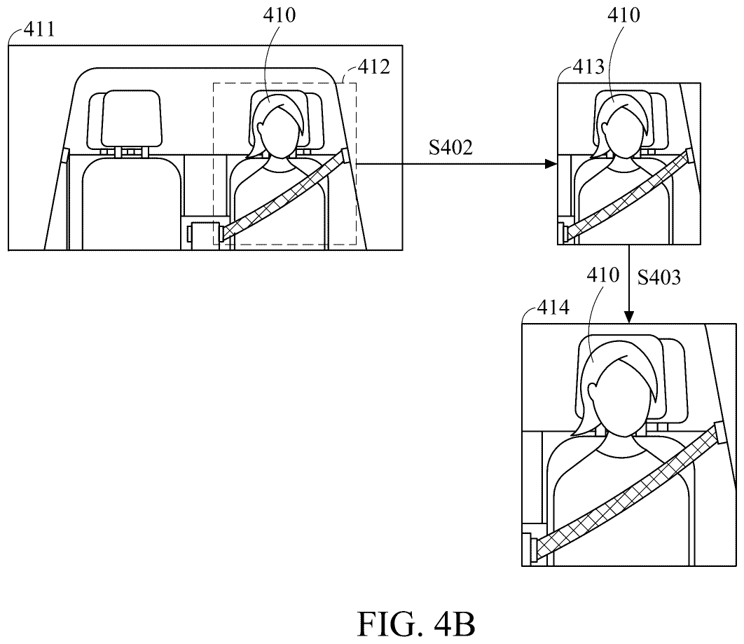

FIG. 4A is a flow diagram illustrating steps S401 to S403 in greater detail as a refinement of step S101 in an embodiment. Corresponding to FIG. 4A, FIG. 4B is a schematic diagram of steps S401 to S403. Please refer to FIGS. 4A and 4B together for a better understanding of this embodiment.

In step S401, a raw image 411 is captured using an image capturing device. The capture scene of the raw image 411 may correspond to seating areas in various transportation vehicles (e.g., automobiles, motorcycles, trains, airplanes, and yachts), construction vehicles (e.g., forklifts, excavators, and cranes), or amusement facilities (e.g., roller coasters, pirate ships, and free-fall rides, but the present disclosure is not limited thereto.

In step S402, the occupant 410 is detected within the raw image 411 to crop a partial image 413 that contains the occupant 410 from the raw image 411. The detection of the occupant 410 may be implemented using machine learning-based object detection models or traditional object detection algorithms such as Haar cascade detectors, template matching, and Hough transform, but the present disclosure is not limited thereto. The detection result yields a rectangular bounding box 412 enclosing the occupant 410. Cropping the raw image 411 along the bounding box 412 yields the partial image 413 containing the occupant 410.

In step S403, the size of the partial image 413 is adjusted to a designated input size to obtain the input image 414. The designated input size may correspond to the input requirements of the instance segmentation model, such as 256×256.

During the execution of steps S401 to S403, certain additional processing may be performed on the raw image 411, the partial image 413, and the input image 414, such as geometric transformation, normalization, smoothing, and/or image enhancement, but the present disclosure is not limited thereto.

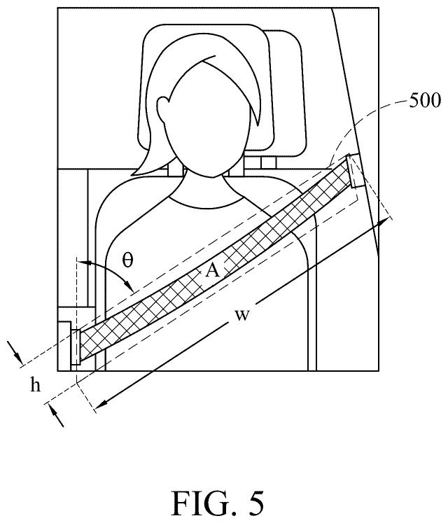

In an embodiment, the attribute data associated with the safety equipment, calculated in step S403, may include the height, width, and rotation angle of a minimum bounding rectangle (MBR) of the safety equipment, as well as the pixel area of the safety equipment. Refer to FIG. 5, which illustrates an example minimum bounding rectangle 500 and the pixel area A of a seat belt, where the minimum bounding rectangle has a height h, a width w, and a rotation angle θ. The rotation angle θ may be defined as the angle between one dimension (height or width) of the minimum bounding rectangle and a horizontal or vertical line, but the present disclosure is not limited thereto. The pixel area A may be defined as the number of pixels within the region occupied by the safety equipment, or as the ratio of the area of the safety equipment region relative to the area of the minimum bounding rectangle 500, but the present disclosure is not limited thereto. In an implementation, the calculation of the minimum bounding rectangle and pixel area may be realized using functions provided by computer vision libraries such as OpenCV, PyTorch, TensorFlow, scikit-image, or MATLAB. For example, OpenCV provides the function cv2.minAreaRect( ) that accepts a contour as input and returns a rotated rectangle that tightly encloses the contour. OpenCV also provides the function cv2.contourArea( ) that accepts a contour as input and returns the pixel area enclosed by the contour.

Additionally, step S403 further includes verifying whether the height h, width w, rotation angle θ of the minimum bounding rectangle 500, and the pixel area A fall within respective designated ranges. The setting of the designated ranges may vary depending on the actual application scenario and is not limited by the present disclosure. For example, the determination criteria may be defined as follows: the height h falls between 50 and 400 pixels, the width w falls between 100 and 300 pixels, the rotation angle θ falls between 30 and 100 degrees, and the pixel area A occupies more than 70% of the area of the minimum bounding rectangle 500. If all the above conditions are satisfied, the occupant is determined to be equipped with the safety equipment. If any condition is not satisfied, the occupant is determined not to be equipped with the safety equipment.

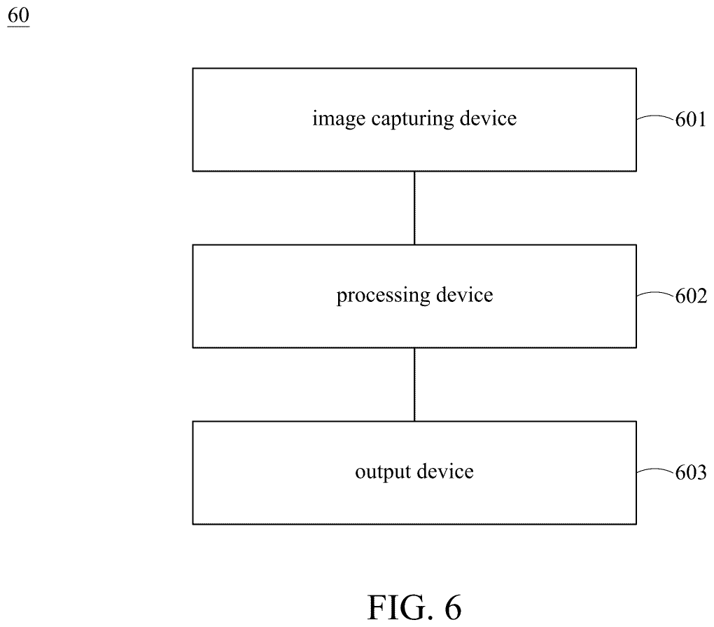

FIG. 6 is a system block diagram of a system 60 for implementing the aforementioned method 10, according to an embodiment of the present disclosure. The system 60 may be any type of computing system with computing capability, such as a personal computer (e.g., desktop or laptop), a server computer, a mobile device (e.g., tablet or smartphone), or an embedded system designed to perform specific tasks with relatively limited computational resources, but the present disclosure is not limited thereto. In an embodiment, the system 60 is an embedded system using a board support package (BSP), which supports a limited variety of neural network types.

The system 60 includes at least a processing device 602 configured to perform the aforementioned steps S101-S104, S402-S403, and their various embodiments. The processing device 602 may include any one or more general-purpose or specialized processors or a combination thereof, such as a Central Processing Unit (CPU), Graphics Processing Unit (GPU), microprocessor, microcontroller, System on a Chip (SoC), Application-Specific Integrated Circuit (ASIC), Field-Programmable Gate Array (FPGA), or any combination thereof, but the present disclosure is not limited thereto.

In an embodiment, the system 60 further includes an image capturing device 601 configured to perform step S401, i.e., to capture a raw image. The image capturing device 601 may include a lens and a conversion element. The lens may include one or more optical elements, such as a zoom lens for scaling the target object and a focusing lens for adjusting the focal distance. The conversion element may be a Charge-Coupled Device (CCD) or a Complementary Metal-Oxide-Semiconductor (CMOS), configured to receive optical signals from the lens and convert them into electrical signals. Additionally, the image capturing device 601 may communicate with the processing device 602 through various wired or wireless communication interfaces, such as Universal Serial Bus (USB), Wi-Fi, Ethernet, Bluetooth, or Near Field Communication (NFC), to transmit the captured image data for further processing and analysis.

In an embodiment, the system 60 further includes an output device 603 configured to issue a warning message when it is determined that the occupant is not equipped with safety equipment. The warning message may take various forms, including but not limited to text, sound, vibration, or light. The warning message may be directed to the occupant or relevant supervisory personnel. The output device 603 may include devices capable of delivering visual, auditory, or tactile signals to the occupant or supervisory personnel, such as a display for text messages, a buzzer for sound alerts, a vibrator for vibration alerts, or a warning light for emitting light signals. The output device 603 may communicate with the processing device through various communication interfaces such as High-Definition Multimedia Interface (HDMI), USB, Wi-Fi, or Bluetooth. In response to determining that the occupant is not equipped with the safety equipment, the processing device 602 causes the output device 603 to issue the warning message.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. A method for detecting a safety equipment, implemented by a computer system, the method comprising:
obtaining an input image containing an occupant;
inputting the input image into a pre-trained instance segmentation model to obtain an instance segmentation result output by the instance segmentation model;
calculating attribute data associated with a safety equipment based on the instance segmentation result; and
determining whether the occupant is equipped with the safety equipment based on the attribute data.

2. The method as claimed in claim 1, wherein the instance segmentation model is implemented using a modified SparseInst network, the modified SparseInst network comprising:
a backbone module, involving extracting multi-scale features of the input image using a backbone;
an encoder module, involving performing a series of feature fusion operations on the multi-scale features to obtain encoded features; and
a decoder module, involving deriving mask features and instance information from the encoded features;
wherein the instance segmentation model further involves deriving the instance segmentation result from the mask features and the instance information.

3. The method as claimed in claim 2, wherein the decoder module comprises:
a mask branch, involving deriving the mask features from the encoded features; and
an instance branch, involving deriving the instance information from the encoded features, the instance information comprising a kernel feature, a predicted class confidence, and a predicted object confidence.

4. The method as claimed in claim 3, wherein the instance branch involves a plurality of convolution layers but does not involve any downsampling layers, and a number of the kernel feature, the predicted class confidence, and the predicted object confidence derived by the instance branch is determined by a size of the input image.

5. The method as claimed in claim 2, wherein the backbone is implemented using a MobileNetV2 network, and the multi-scale features extracted by the backbone have a dimensionality of 128.

6. The method as claimed in claim 2, wherein the encoder module does not involve a pyramid pooling module (PPM).

7. The method as claimed in claim 2, wherein the encoder module and the decoder module both do not involve a coordinate concatenation operation; and
wherein training of the instance segmentation model involves optimizing the modified SparseInst network using a modified loss function, the modified loss function comprising a focal loss, a mask loss, a binary cross entropy loss, and a heatmap loss.

8. The method as claimed in claim 1, wherein obtaining the input image containing the occupant comprises:
capturing a raw image using an image capturing device;
detecting the occupant in the raw image to crop a partial image containing the occupant from the raw image; and
resizing the partial image to a designated input size to obtain the input image.

9. The method as claimed in claim 1, wherein the attribute data comprises a height, a width, and a rotation angle of a minimum bounding rectangle (MBR), and a pixel area; and
wherein determining whether the occupant is equipped with the safety equipment based on the attribute data comprises:
verifying whether the height, the width, the rotation angle of the minimum bounding rectangle, and the pixel area are each within respective designated ranges.

10. The method as claimed in claim 1, wherein the computer system is an embedded system using a board support package (BSP).

11. A safety equipment detection system, comprising a processing device configured to perform steps comprising:
obtaining an input image containing an occupant;
inputting the input image into a pre-trained instance segmentation model to obtain an instance segmentation result output by the instance segmentation model;
calculating attribute data associated with a safety equipment based on the instance segmentation result; and
determining whether the occupant is equipped with the safety equipment based on the attribute data.

12. The system as claimed in claim 11, wherein the instance segmentation model is implemented using a modified SparseInst network, the modified SparseInst network comprising:
a backbone module, involving extracting multi-scale features of the input image using a backbone;
an encoder module, involving performing a series of feature fusion operations on the multi-scale features to obtain encoded features; and
a decoder module, involving deriving mask features and instance information from the encoded features;
wherein the instance segmentation model further involves deriving the instance segmentation result from the mask features and the instance information.

13. The system as claimed in claim 12, wherein the decoder module comprises:
a mask branch, involving deriving the mask features from the encoded features; and
an instance branch, involving deriving the instance information from the encoded features, the instance information comprising a kernel feature, a predicted class confidence, and a predicted object confidence.

14. The system as claimed in claim 13, wherein the instance branch involves a plurality of convolution layers but does not involve any downsampling layers, and a number of the kernel feature, the predicted class confidence, and the predicted object confidence derived by the instance branch is determined by a size of the input image.

15. The system as claimed in claim 12, wherein the backbone is implemented using a MobileNetV2 network, and the multi-scale features extracted by the backbone have a dimensionality of 128.

16. The system as claimed in claim 12, wherein the encoder module does not involve a pyramid pooling module (PPM).

17. The system as claimed in claim 12, wherein the encoder module and the decoder module both do not involve a coordinate concatenation operation; and
wherein training of the instance segmentation model involves optimizing the modified SparseInst network using a modified loss function, the modified loss function comprising a focal loss, a mask loss, a binary cross entropy loss, and a heatmap loss.

18. The system as claimed in claim 12, wherein the instance branch involves a plurality of convolution layers but does not involve any downsampling layers, and a number of the kernel feature, the predicted class confidence, and the predicted object confidence derived by the instance branch is determined by a size of the input image.

19. The system as claimed in claim 11, further comprising:
an image capturing device, communicable with the processing device, and used for capturing a raw image;
wherein the processing device is further configured to detect the occupant in the raw image to crop a partial image containing the occupant from the raw image; and
wherein the processing device is further configured to resize the partial image to a designated input size to obtain the input image.

20. The system as claimed in claim 11, wherein the attribute data comprises a height, a width, and a rotation angle of a minimum bounding rectangle (MBR), and a pixel area; and
wherein the processing device determines whether the occupant is equipped with the safety equipment based on the attribute data by verifying whether the height, the width, the rotation angle of the minimum bounding rectangle, and the pixel area are each within respective designated ranges.
